(19) United States
(12) Patent Application Publication
(10) Pub. No.: US 2023/0219327 A1
(43) Pub. Date: Jul. 13, 2023

(54) ENGINEERED WOOD SIDING, TRIM AND FENCING WITH FIRE RESISTANT PROPERTIES

(71) Applicant: LOUISIANA-PACIFIC CORPORATION, Nashville, TN (US)

(72) Inventors: JIANWEN NI, FRANKLIN, TN (US); G. PAUL MERRICK, GIG HARBOR, WA (US)

(21) Appl. No.: 18/097,048

(22) Filed: Jan. 13, 2023

Related U.S. Application Data
(60) Provisional application No. 63/299,057, filed on Jan. 13, 2022.

(51) Int. Cl. B32B 21/02; B32B 5/24; B32B 21/14; B32B 7/12; B32B 21/10

(52) U.S. Cl. CPC B32B 21/02; B32B 5/24; B32B 21/14; B32B 7/12; B32B 21/10; B32B 2307/3065; B32B 2260/046; B32B 2260/028; B32B 2250/03

(57) ABSTRACT

A multi-layer fire-resistant (FR) panel or board, for use in exterior applications, such as siding, cladding, trim, fencing, or sheathing. The panel or board may be OSB or other form of engineered-wood, with an integrated fire-resistant laminate incorporated during a manufacturing process. The laminate may be placed on top of or under a fines layer. The laminate may be placed under an overlay layer, such as a resin-impregnated paper overlay, or other form of weather- or water-resistant barrier (WRB). The laminate itself may also serve as a WRB, and may thus be combined with or substituted for the overlay layer. A second FR laminate may be applied on the bottom of the panel or board. In addition to providing FR characteristics, the laminate also protects the structural integrity of the panel by preventing or reducing the splitting and/or cracking of the panel or board during a fire event.

This application claims benefit of and priority to U.S. Provisional Application No. 63/299,057, entitled “Fire-Retardant-Treated Engineered Wood Siding, Trim and Fencing,” filed Jan. 13, 2022, which is incorporated herein in its entirety by specific reference for all purposes.

### FIELD OF INVENTION

This invention relates to a multi-layered, reinforced engineered-wood composite panel (which can be wood composite or wood-based panels, such as oriented strand board (OSB), plywood, or other cellulose-based panels) used for exterior applications such as, but not limited to, siding, trim, fencing wall sheathing, roof sheathing, or other sheathing.

### BACKGROUND OF THE INVENTION

Building wall and roof assemblies are commonly comprised of layers of several materials, each performing a specific function, that are installed separately. A typical assembly for residential home construction would include a dimension lumber frame, a plywood or oriented strand board (OSB) sheathing layer and a siding. In some cases, the sheathing and siding can be the same layer, such as a panel siding that is code approved as a sheathing. Wood-based composites, such as OSB, have been found to be acceptable alternatives to veneer-based wood paneling (e.g. softwood plywood) and dimension wood products.

In general, wood-based composites include oriented strand board (OSB), wafer board, flake board, particle board as well as medium density fiberboard (MDF). These wood-based composites are typically formed from a wood material combined with a thermosetting adhesive to bind the wood substrate together. In some processes, the adhesive is combined with other additives to impart additional properties to the wood composites. Additives can include fire retardants, fungicides/mildewcides, insecticides and water repellents. These ingredients can also be added separately from the adhesive, for example when this is more compatible with the manufacturing process. A significant advantage of strand and particle-based wood composites is that they have many of the properties of plywood and dimension lumber but can be made from a variety of lower grade wood species, smaller trees and waste from other wood product processing, and can be formed into panels in lengths and widths independent of size of the harvested timber.

One class of alternative products are multilayer oriented wood strand board products, particularly those with a targeted layer-to-layer oriented strand pattern, such as OSB. These oriented strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on the mat-forming line with the strands of the face layers predominantly oriented in a parallel to machine direction orientation and strands in the core layer oriented, generally, perpendicular to the face layers (e.g., cross-machine) direction.

In one common commercial process these layers are bonded together using natural or synthetic adhesive resins under heat and pressure to make the finished product. Oriented, multilayer wood strand boards of the above described type can be produced with mechanical and physical properties comparable to those of commercial softwood plywood and are used interchangeably, such as for wall and roof sheathing. In certain types of construction, these panels (and other construction materials) may be required by building codes to meet certain durability requirements, such as fire, wind and water resistance.

Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, 6,461,743, and U.S. patent application Ser. No. 17/747,930, all of which are incorporated herein in their entireties by specific reference for all purposes.

Engineered wood siding and trim are specialty grades of oriented strand board that may be attached over sheathing or directly to the wall framing (e.g. in place of sheathing). These products have enhanced properties to perform under exposed, exterior weathering applications. The enhancements may include, but are not limited to, the type and amount of adhesive, the addition of water repellants and preservatives and the application of a resin saturated paper overlay to one or more sides. Engineered wood siding or trim may also be used as a fencing product with appropriate modifications to the manufacturing process described above.

During a fire event, such as, but not limited to, an exterior or external fire event (e.g., wildfire, fire in neighboring building or structure), natural and engineered wood composite products can crack and split, causing them to lose structural integrity and allowing the fire to more deeply penetrate into the building assembly (e.g., an exterior wall exposed to a wildfire). Typical resin-impregnated paper overlays designed and used for exterior exposure do not provide fire resisting or structural reinforcing properties to the underlying oriented strand board substrate. Overlays that do have fire resisting properties are typically limited to interior end uses, where exposure to moisture will not negatively impact their intumescent additives and cause failure of finish paints under wet conditions (e.g., Dion et. al., U.S. Pat. No. 8,808,850, which is incorporated herein by specific reference in its entirety for all purposes). These FR overlays typically contain ingredients that are not compatible with commercial hot-press processes, such as those used to manufacture engineered wood siding and trim. Furthermore, the underlying Kraft paper, even when saturated with resins, is not capable of, nor designed to, prevent cracking of the underlying strand substrate during a fire event (i.e., it has inadequate structural reinforcing properties). These cracks and/or splits may further permit penetration of the fire into the remaining wall assembly or elements.

### SUMMARY OF THE INVENTION

In various exemplary embodiments, the present invention comprises a multi-layer fire-resistant (FR) panel or board for use in exterior applications such as, but not limited to, siding, trim, fencing, wall sheathing, roof sheathing, or other sheathing. The multi-layer panel may comprise a base engineered-wood panel layer, such as OSB. This panel layer may be multilayered, such as multiple layers of oriented strands. An optional fines layer may be placed thereon. In several embodiments, a fire-resistant (FR), and possibly also water-resistant or weather-resistant (weather-resistant including both resistance to water and other external environmental conditions, such as resistance to UV radiation), laminate is then used in place of, or in addition to, the typical resin-impregnated paper overlay that often serves as an outer layer for a panel or board. These components layers may be arranged in various orders, as described below.

In some embodiments, a weather-resistant and fire-resistant laminate serves as the top layer in place of a resin-impregnated paper overlay (i.e., performance overlay). In alternative embodiments, an FR laminate is located between the fines layer on the upper (outer) surface of the base panel layer, and the outermost resin-impregnated paper overlay. In this configuration, the FR laminate typically does not need to be weather-resistant as that function is carried out by the paper overlay layer, which protects the underlying FR laminate, the base panel layer, and any other layers. In a further embodiment, the FR laminate is located between the fines layer and the base panel layer. In yet a further embodiment, there is no fines layer.

The various forms of the FR laminate, including the water/weather-resistant and fire-resistant embodiment, improve the fire resistance of the engineered-wood siding, trim, fencing, or sheathing, as well as improving the structural integrity of the engineered wood product during a fire event by preventing or substantially reducing the cracking and splitting of the product that can occur during a fire event. In several embodiments, the FR laminate gives the final product fire resistant (FR) characteristics, and may be used in one to three hour fire-resistance-rated assemblies, such as those described in U.S. Provisional App. Nos. 63/306,671, filed Feb. 4, 2022, or 63/433,462, filed Dec. 18, 2022 (both of which are incorporated herein in their entireties by specific reference for all purposes), where such FR characteristics are required by building codes.

In several embodiment, the present invention can be used independently or in combination with other products. to meet requirements to reduce wildland fire risk, such as those set forth in the International Code Council's (ICC) International Wildland-Urban Interface Code 2021 (UWUIC 2021), especially, but not limited to, Chapters 5 (Special Building Construction Regulations) and 6 (Fire Protection Requirements), and any subsequent updates and/or versions thereof.

In several exemplary embodiments, the present invention is produced as follows. Strands of wood or lignocellulosic material are coated with adhesive resin, wax and other proprietary additives in blenders. The strands then are oriented into a mat, typically a multilayer mat, on a forming line to form the base panel layer. A FR laminate is placed on the top side or bottom side of the mat. In some embodiments, the FR laminate is placed on both the top side and bottom side of the mat. The mat is then placed in a press where elevated temperature and pressure are applied to consolidate and bond the strands by heat activation and curing of the adhesive resin. The FR laminate must be compatible with typical engineered wood manufacturing processes, such as, but not limited to, a thermal hot press which ensures the laminate bonds to the wood composite matrix.

In several embodiments, an optional fines layer is added. The fines layer may be added to base panel layer, and under the FR laminate. Alternatively, the fines layer may be added to the upper surface of FR laminate, which rests on the base panel layer.

In additional embodiments, an overlay, such as a resin-impregnated paper overlay, is used as the top layer. As noted above, the FR laminate may be combined with and/or substituted for the overlay.

After pressing or formation of the panel, the panel may then be primed, painted and/or coated, depending on the end use application. Branding or markings, if any, to be applied to the panel are then applied or printed on the coated surface of the desired face, such as by using a digital printer or other stamping process. The markings also may be performed in the primary manufacturing process or a secondary manufacturing process.

The various layers (e.g., base layer, fines, FR laminate, overlay) may be pressed together to a single primary pressing process (i.e., applying heat and pressure). Alternatively, one or more of the layers, such as, but not limited to, the FR laminate and/or paper overlay layer, may be added through a secondary pressing process to a panel formed by the primary pressing process.

Thus, in some embodiments the laminate is not placed on the mat prior to the initial or primary pressing. Instead, the laminate may be applied to an engineered wood composite panel, which has already undergone primary pressing, in a secondary laminating process. The secondary laminating process may occur prior to or after the final machining of the initial panel into the desired siding, trim, fence, or sheathing component. In this embodiment, the laminate may be, but need not be, a dry, sheet-like product. The laminate may instead comprise a viscous liquid or semi-solid film that is applied, which then solidifies and bonds to the underlying substrate using suitable and compatible processing (e.g., UV light). Another feature of this embodiment is that the laminate may replace, or be used without the need for, a fines layer. A further feature of this embodiment is that the laminate may be formed (i.e., wrapped) around the edges of the product.

The multi-layer, engineered composite, described in the present invention results in a structurally reinforced and fire-resistant product suitable for those applications where the building-code or other standard requires protections against fire, such as in a wildfire exposure event or in a fire-rated assembly. This novel approach, combining fire resistance with structural reinforcement, may also provide a synergistic benefit when further combined with other strategies, such as those focused on flame spread reduction. End use applications include, but are not limited to, exterior siding, trim, fencing, and sheathing applications in residential, single- or multi-family, and commercial construction.

In panels where one or more of the strand layers of the base OSB panel have FR characteristics (e.g., some or all of the oriented strands have been blended or treated with FR chemicals or materials), the laminate layer, in combination with the overlay protective layer(s), if any, as described above, can help prevent or reduce FRT (fire resistant treatment) chemical loss by limiting or preventing the base panel layer from being exposed to water and/or weather, and by keeping or limiting FRT chemicals from leaching out of the base panel.

Examples of a FR laminate that may be used in the present invention include, but are not limited to, one or more of the following: fire-resistant woven or nonwoven fiberglass veils; fire-retardant fabrics; fire-resistant fabrics or combinations thereof. These FR laminates allow the engineered wood panel to be used in approved fire-rated assemblies, or where FRT protection is needed and or required by building codes.

### BRIEF DESCRIPTION OF THE DRAWINGS

FIG. 1 shows a perspective cutaway view of a reinforced panel with a combined fire and weather/water resistant laminate as the outer layer, in accordance with an embodiment of the present invention.

FIG. 2 shows a perspective cutaway view of a reinforced panel with an FR laminate located between the fines layer and a paper overlay, in accordance with an embodiment of the present invention.

FIG. 3 shows a perspective cutaway view of a reinforced panel with an FR laminate located between the base panel layer and the fines layer, in accordance with an embodiment of the present invention.

FIG. 4 shows a cross-section of the panel of FIG. 1.

FIG. 5 shows a cross-section of the panel of FIG. 2.

FIG. 6 shows a cross-section of the panel of FIG. 3.

FIG. 7 shows a cross-section of the panels of FIG. 5 or 6, without a fines layer.

FIG. 8 shows a cross-section of a panel with a second FR laminate located on the bottom face.

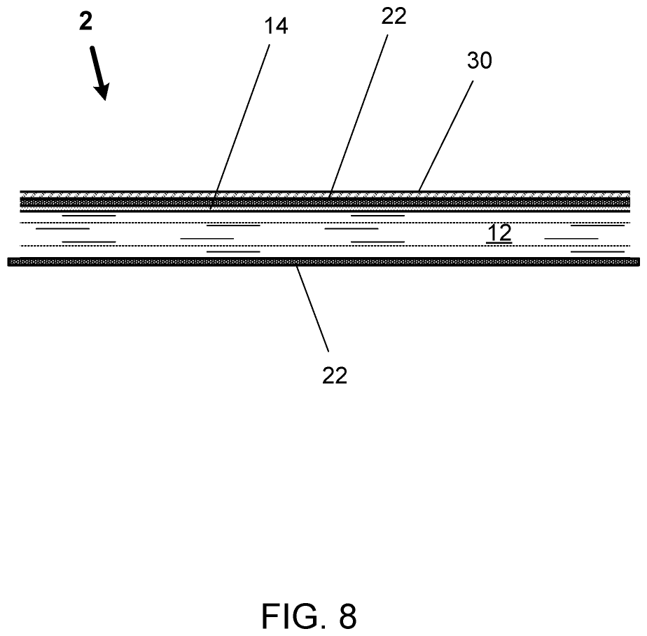

### BRIEF DESCRIPTION OF INVENTION

In various exemplary embodiments, the present invention comprises a multi-layer fire-resistant (FR) panel or board 2 for use in exterior applications such as, but not limited to, siding, trim, fencing, wall sheathing, roof sheathing, or other sheathing. The multi-layer panel or board 2 comprises a base engineered-wood panel layer 10, such as OSB. This base panel layer may be multilayered, such as multiple layers of oriented strands 12. An optional fines layer 14 may be placed thereon. In several embodiments, a fire-resistant (FR), and possibly also water-resistant or weather-resistant (weather-resistant including both resistance to water and other external environmental conditions, such as resistance to UV radiation), laminate 20, 22 is then used in place of, or in addition to, the typical resin-impregnated paper overlay 30 that often serves as an outer layer for a panel or board. These components layers may be arranged in various orders, as described below.

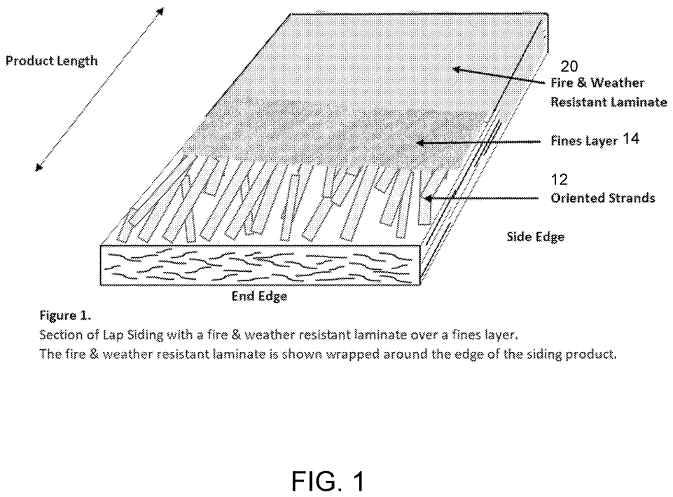

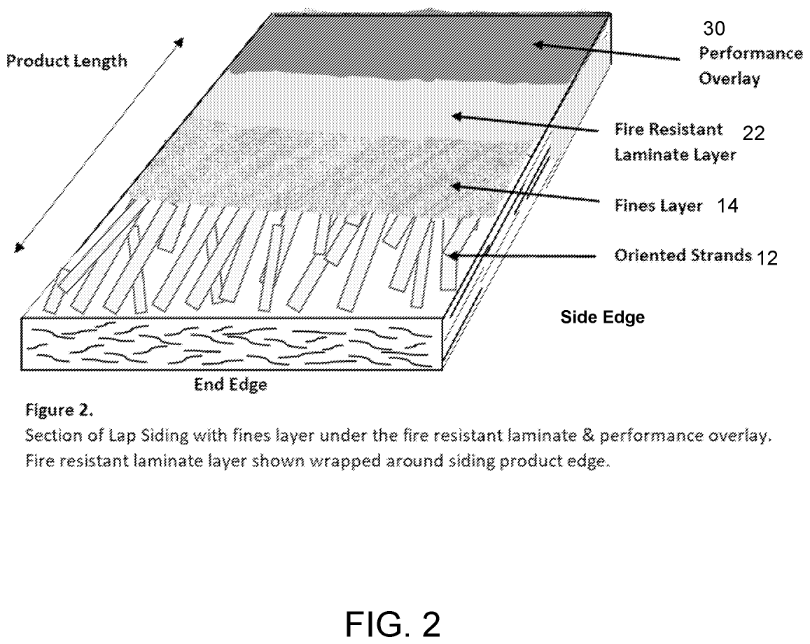

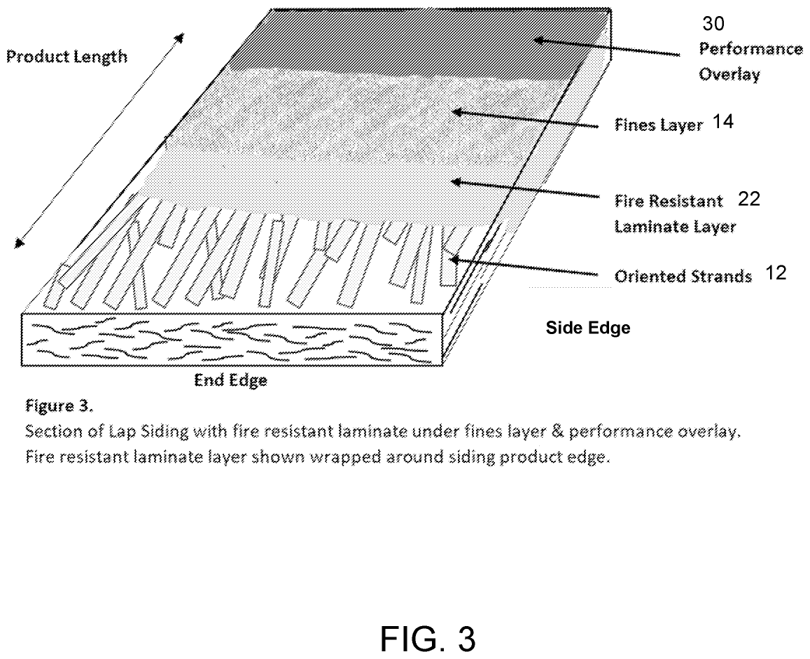

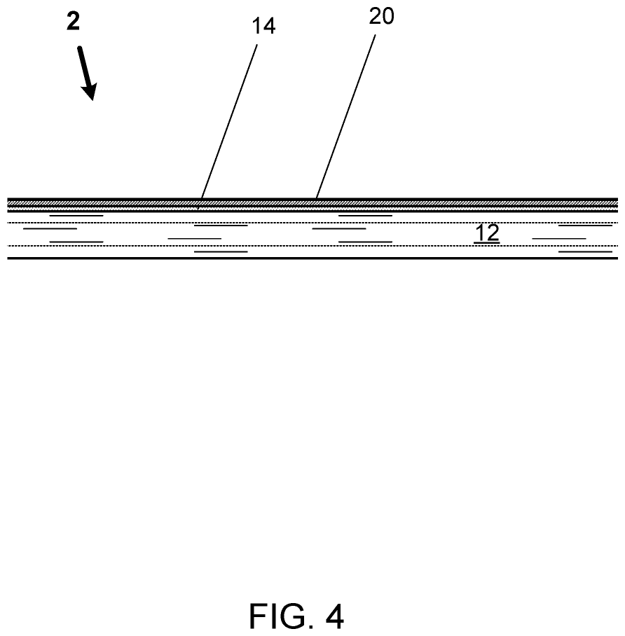

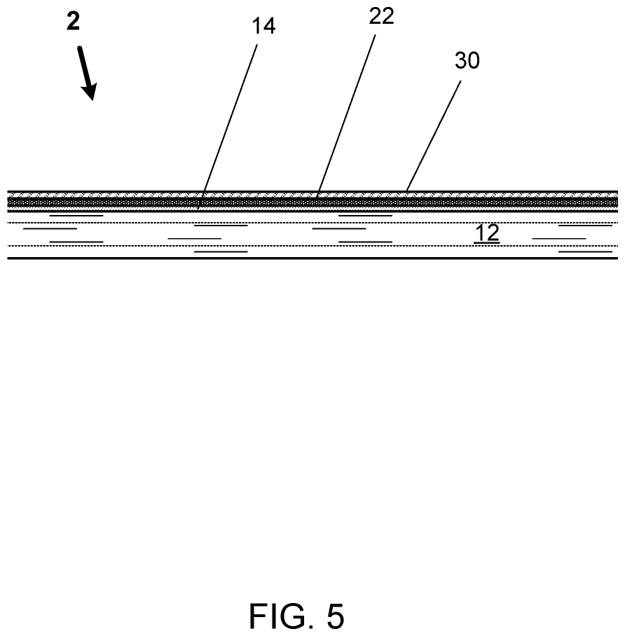

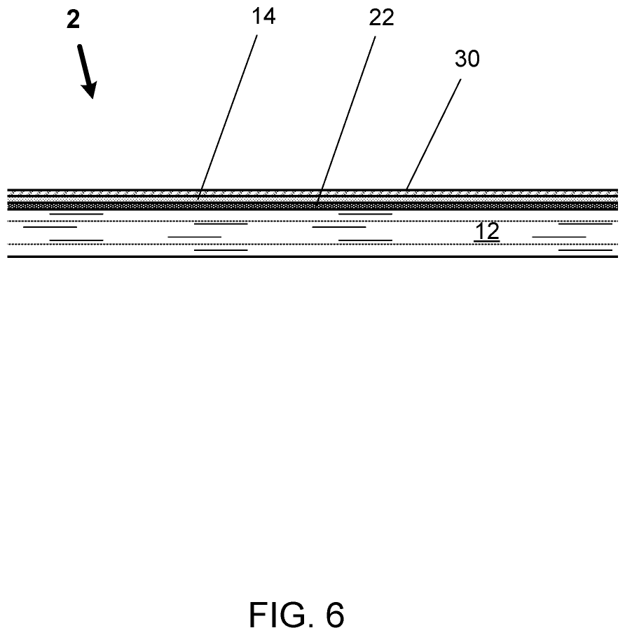

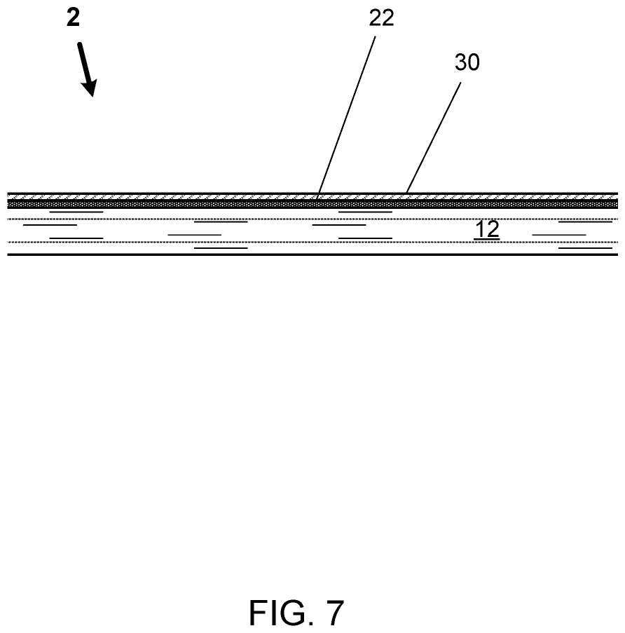

FIGS. 1 and 4 show a weather/water-resistant and fire-resistant laminate 20 serving as the top layer in place of a resin-impregnated paper overlay (i.e., performance overlay). FIGS. 2 and 5 show an FR laminate 22 located between the fines layer 14 on the upper (outer) surface of the base panel layer, and the outermost resin-impregnated paper overlay 30. In this configuration, the FR laminate 22 typically does not need to be weather-resistant as that function is carried out by the paper overlay layer 30, which protects the underlying FR laminate, the base panel layer, and any other layers. In a further embodiment, as seen in FIGS. 3 and 6, the FR laminate is located between the fines layer 14 and the base panel layer 12. In yet a further embodiment, as seen in FIG. 7, there is no fines layer.

The various forms of the FR laminate 20, 22, including the water/weather-resistant and fire-resistant embodiment 20, improve the fire resistance of the engineered-wood siding, trim, fencing, or sheathing product 2, as well as improving the structural integrity of the engineered wood product 2 during a fire event by preventing or substantially reducing the cracking and splitting of the product 2 that can occur during a fire event. In several embodiments, the FR laminate gives the final product 2 fire resistant (FR) characteristics, and may be used in one to three hour fire-resistance-rated assemblies, such as those described in U.S. Provisional App. Nos. 63/306,671, filed Feb. 4, 2022, or 63/433,462, filed Dec. 18, 2022 (both of which are incorporated herein in their entireties by specific reference for all purposes), where such FR characteristics are required by building or other codes.

In several embodiment, the present invention can be used independently or in combination with other products. to meet requirements to reduce wildland fire risk, such as those set forth in the International Code Council's (ICC) International Wildland-Urban Interface Code 2021 (UWUIC 2021), especially, but not limited to, Chapters 5 (Special Building Construction Regulations) and 6 (Fire Protection Requirements), and any subsequent updates and/or versions thereof.

In several exemplary embodiments, the present invention is produced as follows. Strands of wood or lignocellulosic material are coated with adhesive resin, wax and other proprietary additives in blenders. The strands then are oriented into a mat on a forming line to form the base panel layer 12. A fire-resistant laminate 20, 22 is placed on the top side or bottom side of the mat. In some embodiments, the laminate is placed on both the top side and bottom side of the mat. The mat is then placed in a press where elevated temperature and pressure are applied to consolidate and bond the strands by heat activation and curing of the adhesive resin. The fire-resistant laminate must be compatible with typical engineered wood manufacturing processes, such as, but not limited to, a thermal hot press which ensures the laminate bonds to the wood composite matrix through heat activation of curing of the adhesive resin or other adhesives.

In several embodiments, an optional fines layer 14 is added. The fines layer may be added to base panel layer 12, and under the FR laminate 20, 22. Alternatively, the fines layer 14 may be added to the upper surface of FR laminate 22, which rests on the base panel layer.

In additional embodiments, an overlay 30, such as a resin-impregnated paper overlay, is used as the top layer. As noted above, the FR laminate 20 may be combined with and/or substituted for the overlay.

After pressing or formation of the panel, the panel may then be primed, painted and/or coated, depending on the end use application. Branding or markings, if any, to be applied to the panel are then applied or printed on the coated surface of the desired face, such as by using a digital printer or other stamping process. The markings also may be performed in the primary manufacturing process or a secondary manufacturing process.

The various layers (e.g., base layer, fines, FR laminate, overlay) may be pressed together to a single primary pressing process (i.e., applying heat and pressure). Alternatively, one or more of the layers, such as, but not limited to, the FR laminate and/or paper overlay layer, may be added through a secondary pressing process to a panel formed by the primary pressing process.

Thus, in some embodiments the laminate is not placed on the mat prior to the initial or primary pressing. Instead, the laminate may be applied to an engineered wood composite panel, which has already undergone primary pressing, in a secondary laminating process. The secondary laminating process may occur prior to or after the final machining of the initial panel into the desired siding, trim, fence, or sheathing component. In this embodiment, the laminate may be, but need not be, a dry, sheet-like product. The laminate may instead comprise a viscous liquid or semi-solid film that is applied, which then solidifies and bonds to the underlying substrate using suitable and compatible processing (e.g., UV light). Another feature of this embodiment is that the laminate may replace, or be used without the need for, a fines layer. A further feature of this embodiment is that the laminate may be formed (i.e., wrapped) around the edges of the product.

The multi-layer, engineered composite, described in the present invention results in a structurally reinforced and fire-resistant product suitable for those applications where the building-code or other standard requires protections against fire, such as in a wildfire exposure event or in a fire-rated assembly. This novel approach, combining fire resistance with structural reinforcement, may also provide a synergistic benefit when further combined with other strategies, such as those focused on flame spread reduction. End use applications include, but are not limited to, exterior siding, trim, fencing, and sheathing applications in residential, single- or multi-family, and commercial construction.

In panels where one or more of the strand layers of the base OSB panel have FR characteristics (e.g., some or all of the oriented strands have been blended or treated with FR chemicals or materials), the laminate layer, in combination with the overlay protective layer(s), if any, as described above, can help prevent or reduce FRT (fire resistant treatment) chemical loss by limiting or preventing the base panel layer from being exposed to water and/or weather, and by keeping or limiting FRT chemicals from leaching out of the base panel. Examples of FR-treated panels are disclosed in U.S. patent application Ser. No. 15/365,731, filed Nov. 13, 2016, and U.S. patent application Ser. No. 17/491,367, filed Sept. 30, 2021, which are incorporated herein in their entireties by specific reference for all purposes.

In several of the above embodiments, the FR laminate provides both burn-through resistance and flame-spread resistance. The FR laminate applied to the surface of an FRT panel (e.g., an FRT base OSB panel), as described above, thus provides burn-through resistance (and its own flame-spread resistance) in addition to the flame-spread resistance provided by the underlying FRT panel, thereby enhancing overall performance in a fire event, internal or external. This is addition to the FR laminate helping to reduce FRT chemical treatments from leaching from the underlying FRT panel.

Examples of a FR laminate that may be used in the present invention include, but are not limited to, one or more of the following: woven or nonwoven fiberglass veils; woven or nonwoven FR fabrics; or combinations thereof. These FR laminates allow the resulting engineered wood panels, which can be used individually, to also be used in approved fire-rated assemblies, or where FRT protection is needed and or required by building codes, as discussed above.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A fire-resistant integrated panel or board; comprising:
a base substrate layer comprising one or more layers of manufactured-wood strands, said base substrate layer with an upper surface and a lower surface; and
a fire-resistant laminate layer, wherein the fire-resistant laminate layer is both flame-spread resistant and burn-through resistant.

2. The panel or board of claim 1, further comprising a fines layer.

3. The panel or board of claim 2, wherein the fines layer is located between the base substrate layer and the fire-resistant laminate layer.

4. The panel or board of claim 2, wherein the fines layer is located on a surface of the fire-resistant laminate layer opposite the base substrate layer.

5. The panel or board of claim 1, further comprising an outermost layer comprising an weather-resistant and/or water-resistant barrier.

6. The panel or board of claim 5, wherein the outermost layer comprises a resin-impregnated paper overlay.

7. The panel or board of claim 5, wherein the outermost layer is the FR laminate layer.

8. The panel or board of claim 5, wherein the outermost layer is affixed or adhered to a face of the FR laminate layer.

9. The panel or board of claim 1, further comprising a second fire-resistant laminate layer.

10. The panel or board of claim 9, wherein the second fire-resistant laminate layer is both flame-spread resistant and burn-through resistant.

11. The panel or board of claim 9, wherein the second fire-resistant laminate layer is affixed to a bottom surface of the base substrate layer.

12. The panel or board of claim 1, wherein the base substrate layer comprises at least three layers of oriented manufactured-wood strands, including one or more core layers.

13. The panel or board of claim 12, wherein one or more layers of the at least three layers are treated with fire-resistant chemicals.

14. The panel or board of claim 13, wherein the fire-resistant laminate layer resists leach of the fire-resistant chemicals from the base substrate layer.

15. The panel or board of claim 1, wherein the fire-resistant laminate layer provides structural support to the panel or board.

16. The panel or board of claim 1, wherein the fire-resistant laminate layer increases the structural integrity of the panel or board when exposed to fire.

17. The panel or board of claim 16, wherein the fire-resistant laminate layer prevents or reduces cracking and/or splitting of the panel or board when exposed to fire.

18. The panel or board of claim 1, wherein the fire-resistant laminate layer comprises one or more of a woven fiberglass veil, a nonwoven fiberglass veil, a fire-resistant woven fabric, and a fire-resistant nonwoven fabric.
